(19) United States
(12) Patent Application Publication
(10) Pub. No.: US 2025/0337498 A1
(43) Pub. Date: Oct. 30, 2025

(54) POLARIZATION-MULTIPLEXED OPTICAL BI-DIRECTIONAL LINKS USING SYMMETRICAL HARDWARE

(71) Applicant: NVIDIA CORPORATION, Santa Clara, CA (US)

(72) Inventors: Shai COHEN, Haifa (IL); Benjamin Giles LEE, Ridgefield, CT (US); Segev ZARKOVSKY, Tel Aviv (IL)

(21) Appl. No.: 18/946,830

(22) Filed: Nov. 13, 2024

Related U.S. Application Data
(60) Provisional application No. 63/640,818, filed on Apr. 30, 2024.

(51) Int. Cl. H04B 10/532; H04B 10/61; H04J 14/06; H04L 5/00

(52) U.S. Cl. CPC H04B 10/532; H04B 10/614; H04J 14/06; H04L 5/0055

(57) ABSTRACT

One embodiment includes an optical communication channel, a first network device connected to a first end of the optical communication channel, and a second network device connected to a second end of the optical communication channel. At least one of the first network device or the second network device performs polarization tracking of packets of polarization multiplexed bidirectional communications through the optical communication channel.

### CROSS-REFERENCE TO RELATED APPLICATIONS

This application claims priority benefit of the United States Provisional Patent Application titled, “POLARIZATION-MUXED OPTICAL BI-DIRECTIONAL LINKS USING SYMMETRICAL HARDWARE,” filed on Apr. 30, 2024, and having Ser. No. 63/640,818. The subject matter of this related application is hereby incorporated herein by reference.

### BACKGROUND

### Technical Field

Embodiments of the present disclosure relate generally to computer networking and optical communication networks and, more specifically, to techniques for polarization multiplexed optical bi-directional links using symmetrical hardware.

### Description of the Related Art

Optical fiber networks offer fast and generally reliable data transmission between networked devices. In optical fiber networks, optical transceivers and waveguides (e.g., optical fibers) can be employed to send and/or receive light signals modulated with data. A transceiver is a device that can transmit and/or receive a light signal that is communicated through a waveguide, for example to or from another transceiver. The waveguide can act as a conduit through which the light signal passes. A light signal sent from one transceiver to another transceiver over a waveguide may be influenced by properties of the waveguide.

One drawback of optical fiber networks is that these networks often use a unidirectional communication paradigm. For example, a unidirectional communication paradigm can include an optical fiber network that communicates signals through a waveguide in a single direction from a transmitting transceiver to a receiving transceiver. A unidirectional communication paradigm can limit the number of connections to a network device based on physical size of hardware. Further, with a unidirectional communication paradigm, a waveguide can introduce variations in aspects of a signal traversing the waveguide, making bidirectional communications between two devices difficult to maintain.

Some optical fiber networks use bidirectional communication where the optical fiber network communicates signals through a waveguide in both directions to and from each of the transceivers connected to the waveguide. However, the conventional bidirectional optical systems require two different optical carriers such as two different wavelengths or colors of light, asymmetrical hardware such as hardware that differs on each end of a waveguide (e.g., a transceiver at one end of a waveguide transmits signals using one color of light while the other transceiver transmits signals using another color), and/or double the bandwidth per communication channel. Some conventional bidirectional optical systems use different waveguides or communications paths than unidirectional systems, and further require carrier collision avoidance mechanisms. For example, a carrier collision avoidance mechanism can prevent transmitting from both transceivers at the same time, so that one transmission does not interfere with another transmission. Furthermore, wavelength-based bidirectional systems can make connecting the waveguide to each transceiver difficult, because traditional receivers cannot be symmetrical or identical on both sides of a link. A port or module using a particular wavelength or color cannot be connected to another module using the same color. Further, bandwidth must be evenly split among inbound and outbound communications. As a result, conventional bidirectional optical fiber networks are complex to install and implement.

As the foregoing illustrates, what is needed in the art are more effective optical fiber networks.

### SUMMARY

One embodiment of the present disclosure sets forth an electro-optically-implemented method for polarization multiplexed optical bi-directional communications. The method includes transmitting, to a second network device, a first message that includes tracking data. The method includes receiving, from the second network device, a second message that includes the same or different tracking data. The method includes setting a polarization tracking mode of the first network device according to a mutual polarization tracking strategy of the first network device and the second network device. The first polarization tracking mode and a second polarization tracking mode of the second network device are set based on the mutual polarization tracking strategy such that at least one of the first network device or the second network device performs polarization tracking of polarization multiplexed bidirectional communications through the optical communication channel.

Other embodiments of the present disclosure include, without limitation, one or more computer-readable media including instructions for performing steps. The steps transmitting, by a first network device to a second network device through an optical communication channel, a first message that includes tracking data; receiving, by the first network device, a second message that includes the tracking; and setting a first polarization tracking mode of the first network device. The first polarization tracking mode and a second polarization tracking mode of the second device are set such that a single one of the first network device or the second network device performs polarization tracking of polarization multiplexed bidirectional communications through the optical communication channel. Further embodiments include one or more computing systems for performing one or more aspects of the disclosed techniques.

Further embodiments of the present disclosure set forth a system for polarization multiplexed bidirectional communications. The system includes an optical communication channel, a first network device connected to a first end of the optical communication channel, and a second network device connected to a second end of the optical communication channel. At least one of the first network device or the second network device performs polarization tracking of a plurality of packets of the polarization multiplexed bidirectional communications according to mutual polarization tracking rules of the first network device and the second network device.

At least one technical advantage of the disclosed techniques relative to the prior art is that the disclosed techniques simplify hardware deployment and integration while providing additional edge bandwidth density. The disclosed techniques enable connection of communication paths such as fibers to a port of any type. The disclosed techniques also enable these benefits without sacrificing switch radix, thereby reducing fiber costs and optical packaging. Moreover, the disclosed techniques allow asymmetrical allocation of channel capacity for inbound and outbound communications. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a communication system configured to implement one or more aspects of the various embodiments;

FIG. 2 is a block diagram illustrating an exemplar network device of FIG. 1, according to various embodiments;

FIG. 3 illustrates an exemplar recovery for polarization multiplexing using a network device of FIG. 1, according to various embodiments;

FIG. 4 illustrates an exemplar visualization of matrix operations of the communication system of FIG. 1, according to various embodiments;

FIG. 5 is a flow diagram of method steps for setting a tracking mode for a network device of FIG. 1, according to various embodiments; and

FIG. 6 is a flow diagram of method steps for configuring the communication system of FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for implementing polarization multiplexed optical bi-directional links using symmetrical hardware. Some embodiments of the present disclosure include a system for polarization multiplexed bidirectional communications that includes an optical communication channel, a first network device connected to a first end of the optical communication channel, and a second network device connected to a second end of the optical communication channel. The first network device and/or the second network device performs polarization tracking of packets of polarization multiplexed bidirectional communications through the optical communication channel.

In some embodiments the network devices exchange identifiers using a technique that facilitates polarization tracking according to a mutual polarization tracking strategy or set of rules. The system enables symmetrical hardware to be utilized, whether polarization tracking is performed using both network devices or a single one of the network devices. In some embodiments, the symmetrical hardware includes two network devices that communicate through a communication path such as an optical fiber. The network devices exchange identifiers using a technique that facilitates polarization tracking and negotiates which network device maintains polarization tracking. The tracking data enables the network devices to perform polarization tracking, and the identifiers prevent tracking reflected signals. The identifiers can also be used as part of the mutual polarization tracking strategy. More specifically, a first network device transmits, to a second network device, a first message that includes tracking data and a first identifier or other data of the first network device. The first network device receives, from the second network device, a second message that includes the same or different tracking data, as well as a second identifier of the second network device. In some examples, the first network device sets or configures a polarization tracking mode to a leader mode in which polarization tracking is relaxed or disabled, or a follower mode in which polarization tracking is enabled. In various embodiments, the polarization tracking mode is selected based on a relationship between the first identifier and the second identifier, or a random or pseudorandom selection. In further embodiments, the mutual polarization tracking strategy causes both network devices to perform polarization tracking.

The mechanisms disclosed herein have many real-world applications. For example, polarization multiplexed optical bi-directional links or network devices can be used for communications within a single device, between components in a datacenter, and across wide area networks. The polarization multiplexed optical bi-directional network devices may be deployed with new optical fiber installations. As another example, the polarization multiplexed optical bi-directional network devices may be used to retrofit or upgrade existing optical networks.

The above examples are not in any way intended to be limiting. As persons skilled in the art will appreciate, as a general matter, the polarization multiplexed optical bi-directional network devices can be implemented in any suitable systems.

### System Overview

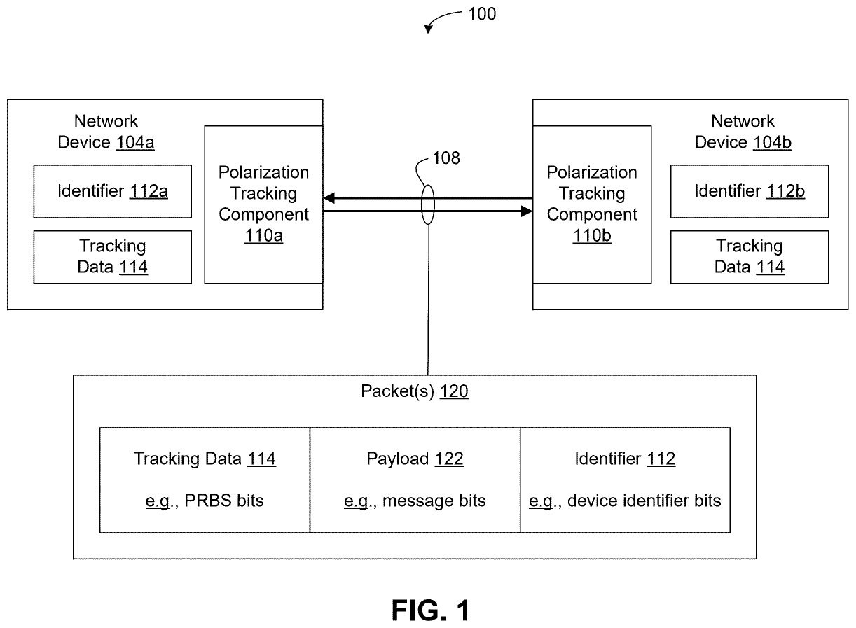

FIG. 1 illustrates a block diagram of a symmetrical and bidirectional polarization multiplexed communication system 100 configured to implement one or more aspects of at least one embodiment. As shown, the polarization multiplexed communication system 100 includes, without limitation, one or more network devices 104a and 104b (network devices 104) and a communication network 108. The network device 104a includes, without limitation, a polarization tracking component 110a, an identifier 112a, and tracking data 114. The network device 104b includes, without limitation, a polarization tracking component 110b, an identifier 112b, and tracking data 114. The network devices 104 transmit one or more packets 120 and other data using the communication network 108. A packet 120 includes, without limitation, an identifier 112, payload data 122, and tracking data 114.

Each of the network devices 104 refers to a device such as a network switch (e.g., an Ethernet switch), a network interface controller (NIC), or any other suitable device used to control the flow of data between devices connected to bidirectional communication network 108. Each of the network devices 104 can be connected to one or more of a Personal Computer (PC), a laptop, a tablet, a smartphone, a server, a collection of servers, or the like. In one specific, but non-limiting example, a network device 104 includes multiple network devices such as a set of switches in a fixed configuration or in a modular configuration. A network device 104 can include a subcomponent of a switch, NIC, or any other suitable device.

Examples of the communication network 108 used to connect between the network devices 104 include, without limitation, an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, at least a portion of the communication network 108 enables communication between the network devices 104 using optical signals in an optical communication pathway or waveguide. The communication network 108 can include a single mode fiber or another type of communications path that imparts random birefringence to signals such as optical signals. As a result, digital communications through the communication network 108 can be associated with a transfer matrix that affects digital communications. The network devices 104 can identify the transfer matrix of the communication network 108. In some embodiments, the network devices 104 use bits corresponding to beacons to identify the transfer matrix of the communication network 108.

Although not explicitly shown, the network device 104a and/or the network device 104b can include storage devices and/or processing circuitry for carrying out computing tasks, for example, tasks associated with controlling the flow of data within each of the network devices 104, over the communication network 108, and/or communications with other devices (not shown). Such processing circuitry can include software, hardware, or a combination thereof. For example, the processing circuitry can include a memory including executable instructions and a processor (e.g., a microprocessor) that executes the instructions on the memory. The memory can correspond to any suitable type of memory device or collection of memory devices configured to store instructions. Non-limiting examples of suitable memory devices that can be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry may comprise hardware, such as an application specific integrated circuit (ASIC). Other non-limiting examples of the processing circuitry include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs.

It should be appreciated that any appropriate type of electrical component or collection of electrical components may be suitable for inclusion in the processing circuitry. In addition, although not explicitly shown, it should be appreciated that the network devices 104 include one or more communication interfaces for facilitating wired and/or wireless communication between one another and other unillustrated components of the system 100. Although not explicitly shown, each of the network devices 104 can include one or more transmitters that transmit optical signals over the communication network 108 and one or more receivers that receive optical signals over the communication network 108. Although not explicitly shown, it should be appreciated that network devices 104a and 104b can include other processing devices, storage devices, and/or communication interfaces generally associated with computing tasks, such as sending and receiving data.

The identifier 112a includes a set of bits that define unique or device-specific data stored by the network device 104a. The identifier 112a identifies the network device 104a from other network devices 104, the polarization tracking components 110a from other tracking components, a date and time of manufacture, or another type of data. Likewise, the identifier 112b includes a set of bits that define a unique identifier stored by the network device 104b. The identifiers 112 can include or represent bits that indicate a number or other comparable data that the network devices 104 (e.g., using the polarization tracking components 110) evaluate or compare to determine which network device 104 in a pair of network devices 104 operates in a leader mode and which operates in follower mode, discussed in greater detail below.

The tracking data 114 can be the same for all network devices 104, so that the tracking data 114 stored in the network device 104a is the same as the tracking data 114 stored in the network device 104b. In some embodiments, the tracking data 114 includes pseudorandom binary sequence (PRBS) bits, or another type of bit pattern or digital sequence. Tracking data 114, in some embodiments, can include a beacon tracking pattern or an acknowledgement tracking pattern that is a different pattern from the beacon tracking pattern. As a result, the polarization tracking components 110 are capable of identifying beacons using the beacon tracking pattern and identifying acknowledgements using the acknowledgment tracking pattern. In some other embodiments, a single tracking pattern can be used, and payload data 122 includes an indication of whether the data is a beacon or an acknowledgement. Payload data 122 can also include any message or data transmitted by a network device 104 in a packet 120.

In operation, the network devices 104a and 104b work in concert to enable polarization multiplexed symmetrical bidirectional communications over the communication network 108. The network devices 104a and 104b perform an auto-negotiation technique that identifies a leader device and a follower device using the polarization tracking components 110, including the polarization tracking component 110a and the polarization tracking component 110b. In the auto-negotiation technique, each of the polarization tracking components 110 transmits a beacon and responds with an acknowledgement. The beacon includes tracking data 114 such as a sequence of bits that is identifiable by all network devices 104. The beacon also includes identifier bits corresponding to an identifier 112. In some embodiments, the beacon also includes message bits of a message transmitted between the network devices 104a and 104b. The auto-negotiation technique also includes each of the polarization tracking components 110a and 110b transmitting acknowledgements in response to detection of beacons. Acknowledgements can also include tracking data 114. In some embodiments, an acknowledgement also includes an identifier 112 of the responding network device 104.

In one example, the polarization tracking component 110a transmits a packet 120 corresponding to a first beacon that includes at least tracking data 114 and an identifier 112a of the network device 104a. The polarization tracking component 110b detects the first beacon and responds by transmitting a first acknowledgement that includes acknowledgement tracking data 114 and an identifier 112b of the network device 104b. The polarization tracking component 110a confirms that tracking is configured correctly and/or successful based on the acknowledgement. The polarization tracking component 110a identifies the acknowledgement based on tracking data 114 and/or payload data 122 that indicates the message is an acknowledgement. Polarization tracking component 110a detects the first acknowledgement and sets a polarization tracking configuration to operate in a leader mode based on a comparison or relationship between the (e.g., local) identifier 112a and the (e.g., remote) identifier 112b. For example, in some embodiments, if the local identifier 112a is greater than (or, in an alternative example, less than) the remote identifier 112b, then the local network device operates in leader mode. Conversely, if the local identifier 112a is less than the remote identifier 112b, then the network device 104a operates in follower mode. The network devices 104 can use any predetermined relationship between the identifiers 112a and 112b to determine which device operates in leader mode and which operates in follower mode.

In this example, the network device 104a can be the leader device that operates in leader mode. In leader mode, the network device 104a stops polarization tracking and sets a local transformation matrix of the polarization tracking component 110a to an identity matrix (or another fixed matrix). In the case of an identity matrix, the matrix does not affect the signal and/or data received through the communication network 108. In leader mode, the network device 104a does not modify the local transformation matrix, and does not detect or identify the transfer matrix. As a result, the network device 104a and the overall polarization multiplexed communication system 100 uses less energy than previous technologies. It is possible for both network devices 104 (e.g., the polarization tracking components 110) to perform tracking and adjusting for polarization. However, the system 100 saves energy by negotiating a leader and a follower such that only the follower network device 104 tracks and adjusts a local transformation matrix.

The polarization multiplexed communication system 100 is a symmetrical system using symmetrical hardware and symmetrical programming (e.g., executable code) for each network device 104. The identifiers 112 and/or tracking data 114 can differ. As a result, the polarization tracking component 110b of network device 104b operates similarly to the polarization tracking component 110a of network device 104a. Continuing the example, the polarization tracking component 110b transmits a packet 120 corresponding to a second beacon that includes at least a beacon tracking data 114 and an identifier 112b of the network device 104b. The polarization tracking component 110a detects the second beacon and responds by transmitting a second acknowledgement that includes an acknowledgement tracking data 114 and the identifier 112a of the network device 104a. The polarization tracking component 110b detects the second acknowledgement and sets a polarization tracking configuration as follower (or leader) based on a comparison or relationship between the local identifier 112b and the remote identifier 112a.

In this example, the network device 104b can be the follower device that operates in follower mode. In follower mode, the network device 104b maintains active polarization tracking using the polarization tracking component 110b. The network device 104b changes or updates a local transformation matrix until tracking data 114 identified in a received packet 120 matches a local copy of the tracking data 114. The network device 104b also confirms that the tracking data 114 identified in a packet 120 is from a remote network device 104 based on the identifier 112. For example, the network device 104b identifies that the packet 120 is from a remote network device 104 if the identifier 112 in the packet 120 is different from a local identifier 112. Otherwise, if the identifier 112 in the packet 120 is the same as a local identifier 112, then the packet 120 is a reflection originating from the local network device 104. Confirmation that the packet 120 is from a remote network device 104 ensures that the network device 104b is performing polarization tracking of the remote network device 104a rather than a reflection. In effect, polarization tracking causes the network device 104b to set a local transformation matrix to a matrix that corrects for the transfer matrix of the communication network 108 and/or the remote transformation matrix of the network device 104a. In examples where the remote transformation matrix of the network device 104a is an identity matrix, the local transformation matrix of the network device 104b is inverse to the transfer matrix of the communication network 108. As a result, the network device 104b and/or the network device 104a can identify the transfer matrix of the communication network 108. The transfer matrix of the communication network 108 can change over time based on temperature and other factors. The network device 104b maintains active polarization tracking and updates the local transformation matrix that corrects for changes to the transfer matrix of the communication network 108.

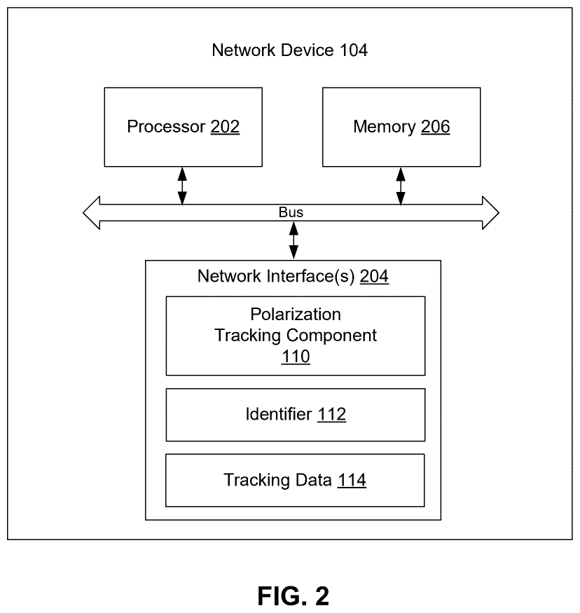

FIG. 2 is a block diagram illustrating an exemplar network device 104 according to various embodiments. The network device 104 may include any type of device, including, without limitation, a switch, a router, a network hub, a modem, a repeater, a controller system, a server machine, a server platform, a desktop machine, a laptop machine, a hand-held/mobile device, a digital kiosk, an in-vehicle infotainment system, and/or one or more devices in a distributed computing system. In some embodiments, network device 104 is an optically networked machine operating in a data center or a cloud computing environment that provides scalable computing resources as a service. The network device 104 includes, without limitation, a processor 202, a network interface 204, and a memory 206. The network interface 204 includes a polarization tracking component 110, an identifier 112, and tracking data 114.

The processor 202 includes any technically feasible processing device configured to process data and execute program instructions. For example, processor 202 could include an application specific integrated circuit (ASIC). Other non-limiting examples of the processing circuitry include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs.

The memory 206 can correspond to any suitable type of memory device or collection of memory devices configured to store instructions. Non-limiting examples of suitable memory devices that can be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry may comprise hardware, such as an application specific integrated circuit (ASIC). Other non-limiting examples of the processing circuitry include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs.

The network interfaces 204 can correspond to any suitable type of networking component that facilitates wired and/or wireless communication between one another and other unillustrated components of the polarization multiplexed communication system 100. The network interfaces 204 can include one or more transmitters that transmit optical signals over the communication network 108 and one or more receivers that receive optical signals over the communication network 108. It should be appreciated that network devices 104 can include any processors 202, memories 206, and/or network interfaces 204 generally associated with computing tasks, such as sending and receiving data.

It will be appreciated that the network device 104 shown herein is illustrative and that variations and modifications are possible. The connection topology may be modified as desired. In certain embodiments, one or more components shown in FIG. 2 may not be present. Lastly, in certain embodiments, one or more components shown in FIG. 2 may be implemented as virtualized resources in a virtual computing environment, such as a cloud computing environment.

### Bidirectional Communications Using Polarization Multiplexing

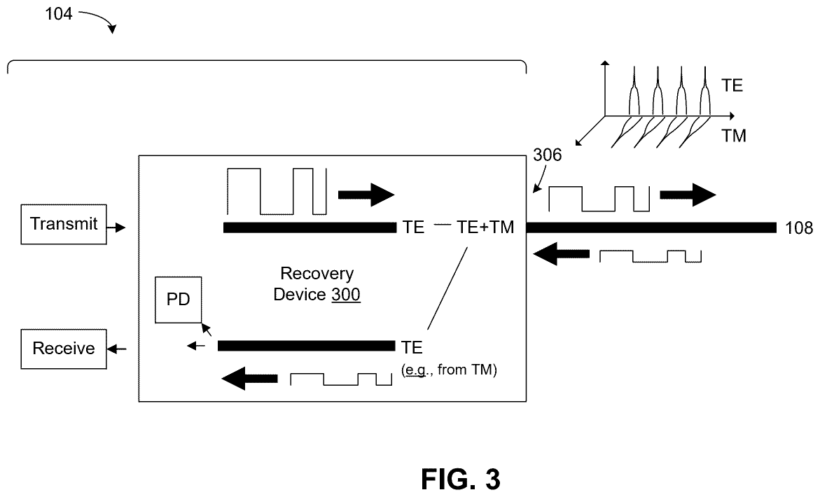

FIG. 3 illustrates an exemplar recovery for polarization multiplexing using a network device 104 of FIG. 1, according to various embodiments. The recovery device 300 communicatively connects components of the network device 104 to the communication network 108. The recovery device 300 includes a bidirectional communication port 306 or other connection to a communication network 108. The recovery device 300 includes, without limitation, subcomponents including a feedback photodetector.

The recovery device 300 enables bidirectional communication through the communication network 108 using a randomly polarized optical signal that includes two components with two different polarizations (e.g., transverse electric (TE) and transverse magnetic (TM) polarization). Polarization can include two degrees of freedom, including relative phase and relative power. The polarized optical signal can include two signal components, and each signal component can include a different phase and/or a different power relative to the other signal component, resulting in two orthogonal or otherwise different polarizations.

The recovery device 300 identifies the optical signal at a bidirectional communication port 306, splits the optical signal into two components (e.g., local signal component and remote signal component), and provides the received or remote signal component in a same polarization (e.g., TE) as the local signal component to be transmitted. The recovery device 300 can include a polarization rotator splitter component that splits and rotates the optical signal.

Example embodiments are shown and described with respect to TE and TM polarization states, however, example embodiments are not limited thereto and may apply to other polarization states (e.g., right circular polarization, left circular polarization, linear +45 degrees polarization, linear −45 degrees polarization, and/or the like). On the network device 104 side of the recovery device 300, the recovery device 300 identifies a transmit signal (e.g., corresponding to a local component of the optical signal) at a transmit port and provides a receive signal (e.g., corresponding to a remote component of the optical signal) at a receive port. An optical fiber of the communication network 108 is connected to a bidirectional communication port 306.

The recovery device 300 and/or the polarization tracking component 110 perform polarization tracking to maximize output power from the recovery device 300 and/or minimizes feedback power to a feedback photodetector (PD) of the recovery device 300. The recovery device 300 can include the polarization tracking component 110 or can be a separate device that works in concert with the polarization tracking component 110. Output power from the recovery device 300 can include power of a signal that is provided to receiving components and/or other components of the network device 104. In some embodiments, a network device 104 (e.g., a tracking component 110 and/or recovery device 300) uses a gradient descent algorithm or operation to minimize feedback power and/or maximize output power.

Further aspects of polarization recovery are described in U.S. Pat. No. 11,588,549. The subject matter of U.S. Pat. No. 11,588,549 is hereby incorporated herein by reference in its entirety.

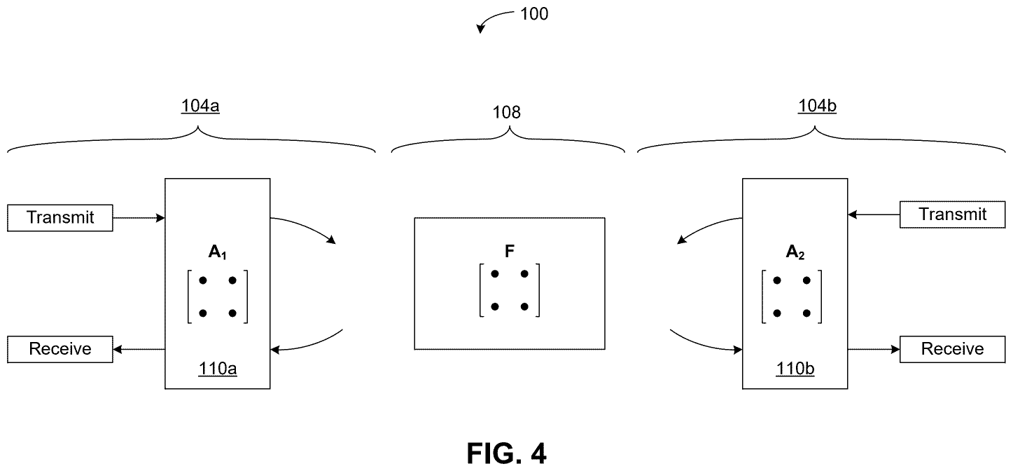

FIG. 4 illustrates an exemplar visualization of matrix operations of the communication system 100 of FIG. 1, according to various embodiments. As shown, the polarization multiplexed communication system 100 includes, without limitation, a network device 104a, and network device 104b, and a communication network 108. The network device 104a includes, without limitation, a polarization tracking component 110a, an identifier 112a, and tracking data 114. The network device 104b includes, without limitation, a polarization tracking component 110b, an identifier 112b, and tracking data 114.

The polarization tracking component 110a of the network device 104a applies a transformation matrix A₁ to digital communications transmitted (and/or received) through the communication network 108. The network device 104a can include a component that applies a transformation matrix A₂ to digital communications transmitted and/or received through the communication network 108. The communication network 108 itself can be associated with a fiber transfer matrix F that affects digital communications transmitted through the communication network 108. Each of the network devices 104a and 104 can use data in packets 120 transmitted through the communication network 108 to modify a local transformation matrix to account for the fiber transfer matrix F and/or the remote transformation matrix of the other network device 104. Polarization tracking in this context include modifying the local transformation matrix over time to account for changes in conditions, as exemplified by the effective transfer matrix F of the communication network 108 and/or the remote transformation matrix of the other network device 104.

In an ideal or target scenario, the transfer matrix F of the communication network 108 is an exchange matrix (e.g., row-reversed matrix, column-reversed matrix, reversal matrix, backward identity matrix, or standard involutory permutation matrix) as shown in equation (1).

$$F = [ \begin{matrix}0 & 1 \\ 1 & 0\end{matrix} ] \qquad ( 1 )$$

A₁ and A₂ are identity matrices (e.g., I), shown in equations (2) and (3). Alternatively, in some embodiments, A₁ and A₂ could be constant but not identity matrices.

$${A}_{1} = [ \begin{matrix}1 & 0 \\ 0 & 1\end{matrix} ] = I \qquad ( 2 )$$

$${A}_{2} = [ \begin{matrix}1 & 0 \\ 0 & 1\end{matrix} ] = I \qquad ( 3 )$$

Accordingly, in the target scenario, equation (4) represents the communication system 100.

$${A}_{1} F {A}_{2} = I [ \begin{matrix}0 & 1 \\ 1 & 0\end{matrix} ] I \qquad ( 4 )$$

And because any matrix multiplied by an identity matrix/is the original matrix, regardless of the order of multiplication, equation (5) can represent a target for communication systems 100.

$${A}_{1} F {A}_{2} = [ \begin{matrix}0 & 1 \\ 1 & 0\end{matrix} ] \qquad ( 5 )$$

However, in a realistic scenario, a single mode optical fiber or another introduces variations to the communication network 108 such that the transfer matrix F is unknown. In an example where the network device 104a operates in follower mode, the polarization tracking component 110a maintains polarization tracking by setting A₁ for any fiber transfer matrix F. In an instance in which the network device 104b locks or sets A₂ as an identity matrix, polarization tracking component 110a sets A₁ according to equation (6).

$${A}_{1} = [ \begin{matrix}0 & 1 \\ 1 & 0\end{matrix} ] {F}^{- 1} \qquad ( 6 )$$

However, because the polarization tracking component 110a dynamically sets local transformation matrix A₁ using a feedback based approach that modifies A₁ until tracking data 114 identified in a received packet 120 matches a local copy of the tracking data 114, the polarization tracking component 110a is capable of concurrently correcting for any arbitrary fiber transfer matrix F as well as any arbitrary transformation matrix locked as a static set of values by the network device 104b, as indicated in equation (7).

$${A}_{1} = [ \begin{matrix}0 & 1 \\ 1 & 0\end{matrix} ] {( {FA}_{2} )}^{- 1} \qquad ( 7 )$$

Equations (6) and (7) are expressed in a scenario where the polarization tracking component 110a of the network device 104a maintains polarization tracking by setting A₁. Equations (6) and (7) solve equation (5) for A₁ to show the local transformation matrix set by polarization tracking component 110a. However, in a scenario where the polarization tracking component 110b of the network device 104b maintains polarization tracking by setting A₂, and A₁ is locked as a static set of values (e.g., an identity matrix or any other matrix), equation (5) can be solved for A₂ to express the local transformation matrix A₂ that is dynamically set by polarization tracking component 110b.

The polarization tracking (e.g., using equations (6) and/or (7) to set A₁) can include an operation that maximizes output power from the recovery device 300 and/or minimizes power to a feedback photodetector of the recovery device 300. In some embodiments, a network device 104 (e.g., a tracking component 110 and/or recovery device 300) uses a gradient descent algorithm or operation to minimize feedback power and/or maximize output power and set A₁. Minimizing feedback power and/or maximizing output power at one network device 104 causes the signal components to properly orient for recovery at both network devices 104. The polarization tracking in some examples, can include maximizing a signal component associated with a first polarization (e.g., TE, TM, etc.) and/or include minimizing a signal component associated with a second polarization relative to communications in the communication network 108. Tracking polarization at a single network device 104 while the other remains static (e.g., frozen or locked) enables output power for both polarization signal components to be properly oriented for bidirectional communications at both network devices 104. However, both network devices 104 can concurrently perform tracking in other examples. The symmetrical hardware of each of the network devices 104 is configured to perform a predefined mutual polarization tracking strategy. In various embodiments, the mutual polarization tracking strategy causes a single network device 104 to perform polarization tracking, or causes both network devices 104 to perform polarization tracking.

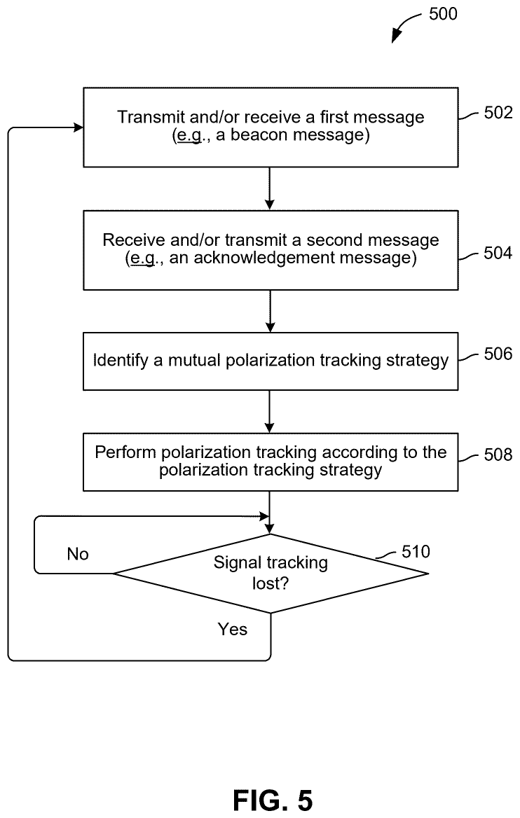

FIG. 5 is a flow diagram of method steps for setting a tracking mode for a network device of FIG. 1, according to various embodiments. Although the method steps are described in conjunction with the components and systems of FIGS. 1-4, persons skilled in the art will understand that any system configured to perform the method steps in any order falls within the scope of the present embodiments.

As shown, a method 500 begins at step 502, where a local network device 104 transmits and/or receives a first message (e.g., a packet 120). The first message can include a beacon message. However, the described techniques can also be performed with any type of message that includes tracking data 114 and a first identifier 112. The first message can also include payload data 122. In some embodiments the first message includes an indication that the first message is a beacon message. The first identifier 112 or other identifying data is specific to the originating or transmitting device. As a result, if the first message is transmitted from the local network device 104, then the first identifier 112 identifies the local network device 104. However, if the first message is received from a remote network device 104, then the first identifier 112 identifies the remote network device 104.

In instances in which the local network device 104 receives the first message from a remote network device 104, the local network device 104 performs a polarization tracking or tuning technique that dynamically sets or updates local transformation matrix using a feedback-based approach using the tracking data 114. The local network device 104 performs polarization tracking by modifying the local transformation matrix until tracking data 114 identified in the (received) first message matches a local copy of the tracking data 114. In some embodiments, until the local network device 104 and/or the remote network device 104 negotiate which device operates in leader mode and which operates in follower mode, both network devices 104 can perform polarization tracking based on messages that are received (e.g., include an identifier 112 that is different from the local identifier 112). As a result, if the local network device 104 transmits the first message, the remote network device 104 performs a polarization tracking or tuning technique that dynamically updates the remote transformation matrix by modifying the remote transformation matrix until tracking data 114 identified in the (transmitted) first message matches a copy of the tracking data 114 stored on the remote network device 104.

At step 504, the local network device 104 receives and/or transmits a second message. The second message can include an acknowledgement message. However, the described techniques can also be performed with any type of message that includes tracking data 114 and a second identifier 112. The second message can also include a payload data 122. In some embodiments the second message includes an indication that the second message is an acknowledgement message. As with the first identifier 112, the second identifier 112 is specific to the originating or transmitting device. As a result, if the second message is transmitted from the local network device 104, then the second identifier 112 identifies the local network device 104. However, if the second message is received from a remote or remote network device 104, then the second identifier 112 identifies the remote network device 104.

In instances in which the local network device 104 receives the second message from a remote network device 104, the local network device 104 performs a polarization tracking or tuning technique that dynamically updates a local transformation matrix using a feedback-based approach that modifies the local transformation matrix until tracking data 114 identified in the (received) second message matches a local copy of the tracking data 114. However, if the local network device 104 transmits the second message, the remote network device 104 performs polarization tracking by modifying the remote transformation matrix until tracking data 114 identified in the (transmitted) second message matches a copy of the tracking data 114 stored on the remote network device 104.

At step 506, the local network device 104 identifies a mutual polarization tracking strategy. The mutual polarization tracking strategy can be a shared set or rules or instructions so that the network devices 104 agree how to perform polarization tracking using the local network device 104, the remote network device 104, or both. The symmetrical hardware of the network devices 104 perform polarization tracking according to a mutual polarization tracking strategy, which is preconfigured with respect to each of the network devices 104. The network devices 104 can include symmetrical hardware and programming. However, the network devices 104 can include different identifying data such as identifiers 112. The shared or mutual polarization tracking strategy can indicate to use a single network device 104 to perform polarization tracking, for example, according to the identifiers 112 or another strategy. Alternatively, the mutual polarization tracking strategy can configure both network devices 104 to perform polarization tracking. The local network device 104 can, in some embodiments, identify a relationship between the first identifier 112 in the first message and the second identifier 112 in the second message. For example, the first identifier 112 can be greater than, less than, or otherwise distinguished from the second identifier 112. In some embodiments, all network devices 104 can store the same rule or rules by which the relationship between the identifiers 112 is assessed to determine which network device 104 performs polarization tracking for the system. The network devices 104 can use any predetermined rule to assess the relationship between the identifiers 112, such as a rule indicating that the network device 104 with the largest identifier 112 performs polarization tracking. Other rules can indicate that the network device 104 with the smallest, most recent, oldest (and so on) identifier 112 performs polarization tracking.

Alternatively, the local network device 104 identifies a single network device 104 to perform polarization tracking based on a random or pseudorandom decision. In the example of a random or pseudorandom decision, the local network device 104 transmits payload data 122 that includes an indication of which network device 104 is to perform polarization tracking. As a result, both network devices 104 operate according to the same decision. In some embodiments, each of the network devices 104 is configured to select itself to perform polarization tracking, such that the network device 104 that is first to receive and successfully modify its transformation matrix becomes follower.

At step 508, the local network device 104 performs polarization tracking according to the mutual polarization tracking strategy. For example, the local network device 104 sets its polarization tracking mode to leader mode or follower mode based on the decision identified in step 506. For example, the local network device 104 can set its polarization tracking mode to leader mode and lock the local transformation matrix. The local transformation matrix can be locked at its current set of values, to an identity matrix, or another static set of values. In that example, the remote network device 104 performs polarization tracking. Alternatively, the local network device 104 sets its polarization tracking mode to follower mode and dynamically updates the local transformation matrix to perform polarization tracking. The network devices 104 can bidirectionally communicate data packets 120 for any purpose, maintaining polarization tracking using a single one of the network devices 104. Using a single one of the network devices 104 for polarization tracking can reduce power and energy relative to other techniques.

At step 510, the local network device 104 determines whether signal tracking is lost. For example, signal tracking is lost if the local network device 104 fails to recover a packet 120 (e.g., data including tracking data 114, payload data 122, and an identifier 112). If signal tracking is lost, the local network device 104 can move to step 502 to repeat the auto-negotiation indicated in steps 502-508. Otherwise, the local network device 104 continues to communicate data with the remote network device 104.

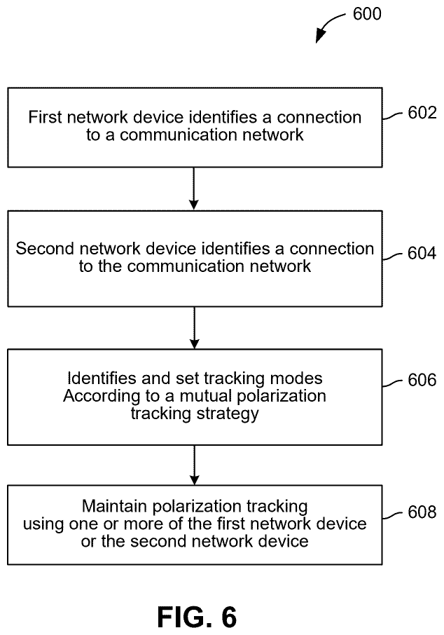

FIG. 6 is a flow diagram of method steps for configuring the communication system of FIG. 1, according to various embodiments. Although the method steps are described in conjunction with the components and systems of FIGS. 1-4, persons skilled in the art will understand that any system configured to perform the method steps in any order falls within the scope of the present embodiments.

As shown, a method 600 begins at step 602, where a first network device 104 connects to a communication network 108. The first network device 104 can identify that an optical fiber or other communication network 108 is connected to a port of the first network device 104. The port can be a bidirectional communication port 306 of an PRS 300 of the first network device 104.

At step 604, a second network device 104 connects to a communication network 108. The first network device 104 can identify that an optical fiber or other communication network 108 is connected to a port of the second network device 104. The port can be a bidirectional communication port 306 of an PRS 300 of the second network device 104. Initially, both the first network device 104 and the second network device 104 perform polarization tracking concurrently.

At step 606, the first network device 104 and the second network device 104 perform an auto-negotiation that identifies and asymmetrically sets tracking modes for the first network device 104 and the second network device 104. As a result, one of the network devices 104 is set to leader mode and one of the network devices 104 is set to follower mode. The auto-negotiation can be performed according to, for example, the method 500 described above in conjunction with FIG. 5. For example, the first network device 104 and the second network device 104 can execute instructions that implement a mutual polarization tracking strategy, which is preconfigured with respect to each of the network devices 104.

At step 608, a communication system 100 including the first network device 104, the second network device 104, and the communication network 108, maintains polarization tracking using one or more of the first network device 104 and the second network device 104. The first network device 104 and the second network device 104 have symmetrical hardware and programming. However, the auto-negotiation technique enables the communication system 100 to use a single one (or both) of the network devices 104 for polarization tracking. The network devices 104 can include symmetrical hardware and programming. However, the network devices 104 can include different identifying data such as identifiers 112. The shared or mutual polarization tracking strategy can indicate to use a single network device 104 to perform polarization tracking, for example, according to the identifiers 112 or another strategy. Alternatively, the mutual polarization tracking strategy can configure both network devices 104 to perform polarization tracking.

In sum, techniques are disclosed for implementing polarization multiplexed optical bi-directional links using symmetrical hardware. In some embodiments, the symmetrical hardware includes two network devices that communicate through a communication path such as an optical fiber. The network devices exchange identifiers using a technique that facilitates polarization tracking using one or more of the network devices. More specifically, a first network device transmits, to a second network device, a first message that includes tracking data. The first network device receives, from the second network device, a second message that includes the same or different tracking data. The first network device sets or configures a polarization tracking mode of the first network device according to a mutual polarization tracking strategy of the first network device and the second network device. The first polarization tracking mode and a second polarization tracking mode of the second network device are set based on the mutual polarization tracking strategy such that at least one of the first network device or the second network device performs polarization tracking of polarization multiplexed bidirectional communications through the optical communication channel. In various embodiments, the polarization tracking mode is selected based on a relationship between the first identifier and the second identifier, or a random or pseudorandom selection.

Further embodiments include a system for polarization multiplexed bidirectional communications that includes an optical communication channel, a first network device connected to a first end of the optical communication channel, and a second network device connected to a second end of the optical communication channel. A single one of the first network device or the second network device performs polarization tracking of packets of polarization multiplexed bidirectional communications through the optical communication channel.

At least one technical advantage of the disclosed techniques relative to the prior art is that the disclosed techniques simplify hardware deployment and integration while providing additional edge bandwidth density. The disclosed techniques enable connection of communication paths such as fibers to a port of any type. The disclosed techniques also enable these benefits without sacrificing switch radix, thereby reducing fiber costs and optical packaging. Moreover, the disclosed techniques allow asymmetrical allocation of channel capacity for inbound and outbound communications. These technical advantages represent one or more technological improvements over prior art approaches.

The following clauses describe some embodiments of the present disclosure 1. In some embodiments, an electro-optically-implemented method for polarization multiplexed optical bi-directional communications comprises transmitting, by a first network device to a second network device through an optical communication channel, a first message that includes tracking data, receiving, by the first network device, a second message that includes the tracking data, and setting a first polarization tracking mode of the first network device according to a mutual polarization tracking strategy of the first network device and the second network device, wherein the first polarization tracking mode and a second polarization tracking mode of the second network device are set based on the mutual polarization tracking strategy such that at least one of the first network device or the second network device performs polarization tracking of polarization multiplexed bidirectional communications through the optical communication channel.

2. The electro-optically-implemented method of clause 1, wherein the first message further includes first data of the first network device, the second message further includes second data of the second network device, and setting the first polarization tracking mode is based on a relationship between the first data and the second data.

3. The electro-optically-implemented method of clauses 1 or 2, wherein the first polarization tracking mode is set to a leader mode that configures the first network device to cease polarization tracking by setting a transformation matrix of the first network device to a static set of values.

4. The electro-optically-implemented method of any of clauses 1-3, wherein the first polarization tracking mode is set to a follower mode that configures the first network device to perform polarization tracking by dynamically updating a set of values of a transformation matrix of the first network device.

5. The electro-optically-implemented method of any of clauses 1-4, wherein the second message further includes second data of the second network device, and the first network device uses the second data to determine that the second message is not a reflected message originating from the first network device.

6. The electro-optically-implemented method of any of clauses 1-5, wherein the first message is a beacon message, and the second message is an acknowledgement message received based on the beacon message.

7. The electro-optically-implemented method of any of clauses 1-6, wherein the first message further includes payload data.

8. The electro-optically-implemented method of any of clauses 1-7, wherein the first network device includes symmetrical hardware and symmetrical programming with respect to the second network device.

9. The electro-optically-implemented method of any of clauses 1-8, further comprising transmitting, by the first network device to the second network device, an indication of the single one of the first network device or the second network device to perform polarization tracking.

10. The electro-optically-implemented method of any of clauses 1-9, wherein the tracking data includes a predetermined sequence for polarization tracking.

11. In some embodiments, one or more non-transitory computer-readable media store instructions that, when executed by at least one processor, cause the at least one processor to perform the steps of transmitting, by a first network device to a second network device through an optical communication channel, a first message that includes tracking data, receiving, by the first network device, a second message that includes the tracking data, and setting a first polarization tracking mode of the first network device according to a mutual polarization tracking strategy of the first network device and the second network device, wherein the first polarization tracking mode and a second polarization tracking mode of the second device are set such that one or more of the first network device or the second network device performs polarization tracking of polarization multiplexed bidirectional communications through the optical communication channel.

12. The one or more non-transitory computer-readable media of clause 11, wherein the first message further includes first data of the first network device, the second message further includes second data of the second network device, and setting the first polarization tracking mode is based on a relationship between the first data and the second data.

13. The one or more non-transitory computer-readable media of clauses 11 or 12, wherein setting the first polarization tracking mode is based on a random or pseudorandom selection of the single one of the first network device or the second network device to maintain polarization tracking.

14. The one or more non-transitory computer-readable media of any of clauses 11-13, wherein the first message includes an identifier of the first network device, and the first network device prevents tracking a reflection of the first message based on the identifier.

15. The one or more non-transitory computer-readable media of any of clauses 11-14, wherein the polarization multiplexed bidirectional communications are transmitted through the optical communication channel via at least two different polarizations.

16. In some embodiments, a system for polarization multiplexed bidirectional communications comprises an optical communication channel, a first network device connected to a first end of the optical communication channel, and a second network device connected to a second end of the optical communication channel, wherein at least one of the first network device or the second network device performs polarization tracking of a plurality of packets of the polarization multiplexed bidirectional communications according to mutual polarization tracking rules of the first network device and the second network device.

17. The system of clause 16, wherein the first network device includes symmetrical hardware and symmetrical programming with respect to the second network device.

18. The system of clauses 16 or 17, wherein the polarization tracking includes dynamically updating a first transformation matrix of a single one of the first network device or the second network device, and wherein a second transformation matrix of another one of the first network device or the second network device is statically set.

19. The system of any of clauses 16-18, wherein the optical communication channel includes a single mode fiber.

20. The system of any of clauses 16-19, wherein the single one of the first network device or the second network device is selected based on a relationship between a first identifier of the first network device and a second identifier of the second network device.

21. The system of any of clauses 16-20, wherein the single one of the first network device or the second network device is identified based on a random or pseudorandom selection.

Any and all combinations of any of the claim elements recited in any of the claims and/or any elements described in this application, in any fashion, fall within the contemplated scope of the present disclosure and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. An electro-optically-implemented method for polarization multiplexed optical bi-directional communications, the method comprising:
transmitting, by a first network device to a second network device through an optical communication channel, a first message that includes tracking data;
receiving, by the first network device, a second message that includes the tracking data; and
setting a first polarization tracking mode of the first network device according to a mutual polarization tracking strategy of the first network device and the second network device,
wherein the first polarization tracking mode and a second polarization tracking mode of the second network device are set based on the mutual polarization tracking strategy such that at least one of the first network device or the second network device performs polarization tracking of polarization multiplexed bidirectional communications through the optical communication channel.

2. The electro-optically-implemented method of claim 1, wherein the first message further includes first data of the first network device, the second message further includes second data of the second network device, and setting the first polarization tracking mode is based on a relationship between the first data and the second data.

3. The electro-optically-implemented method of claim 1, wherein the first polarization tracking mode is set to a leader mode that configures the first network device to cease polarization tracking by setting a transformation matrix of the first network device to a static set of values.

4. The electro-optically-implemented method of claim 1, wherein the first polarization tracking mode is set to a follower mode that configures the first network device to perform polarization tracking by dynamically updating a set of values of a transformation matrix of the first network device.

5. The electro-optically-implemented method of claim 1, wherein the second message further includes second data of the second network device, and the first network device uses the second data to determine that the second message is not a reflected message originating from the first network device.

6. The electro-optically-implemented method of claim 1, wherein the first message is a beacon message, and the second message is an acknowledgement message received based on the beacon message.

7. The electro-optically-implemented method of claim 1, wherein the first message further includes payload data.

8. The electro-optically-implemented method of claim 1, wherein the first network device includes symmetrical hardware and symmetrical programming with respect to the second network device.

9. The electro-optically-implemented method of claim 8, further comprising:
transmitting, by the first network device to the second network device, an indication of the single one of the first network device or the second network device to perform polarization tracking.

10. The electro-optically-implemented method of claim 1, wherein the tracking data includes a predetermined sequence for polarization tracking.

11. One or more non-transitory computer-readable media storing instructions that, when executed by at least one processor, cause the at least one processor to perform the steps of:
transmitting, by a first network device to a second network device through an optical communication channel, a first message that includes tracking data;
receiving, by the first network device, a second message that includes the tracking data; and
setting a first polarization tracking mode of the first network device according to a mutual polarization tracking strategy of the first network device and the second network device,
wherein the first polarization tracking mode and a second polarization tracking mode of the second device are set such that one or more of the first network device or the second network device performs polarization tracking of polarization multiplexed bidirectional communications through the optical communication channel.

12. The one or more non-transitory computer-readable media of claim 11, wherein the first message further includes first data of the first network device, the second message further includes second data of the second network device, and setting the first polarization tracking mode is based on a relationship between the first data and the second data.

13. The one or more non-transitory computer-readable media of claim 11, wherein setting the first polarization tracking mode is based on a random or pseudorandom selection of the single one of the first network device or the second network device to maintain polarization tracking.

14. The one or more non-transitory computer-readable media of claim 11, wherein the first message includes an identifier of the first network device, and the first network device prevents tracking a reflection of the first message based on the identifier.

15. The one or more non-transitory computer-readable media of claim 11, wherein the polarization multiplexed bidirectional communications are transmitted through the optical communication channel via at least two different polarizations.

16. A system for polarization multiplexed bidirectional communications, the system comprising:
an optical communication channel;
a first network device connected to a first end of the optical communication channel; and
a second network device connected to a second end of the optical communication channel,
wherein at least one of the first network device or the second network device performs polarization tracking of a plurality of packets of the polarization multiplexed bidirectional communications according to mutual polarization tracking rules of the first network device and the second network device.

17. The system of claim 16, wherein the polarization tracking includes dynamically updating a first transformation matrix of a single one of the first network device or the second network device, and wherein a second transformation matrix of another one of the first network device or the second network device is statically set.

18. The system of claim 16, wherein the optical communication channel includes a single mode fiber.

19. The system of claim 16, wherein the single one of the first network device or the second network device is selected based on a relationship between a first identifier of the first network device and a second identifier of the second network device.

20. The system of claim 16, wherein the single one of the first network device or the second network device is identified based on a random or pseudorandom selection.
